(19) United States
(12) Patent Application Publication
(10) Pub. No.: US 2026/0368462 A1
(43) Pub. Date: Nov. 19, 2026

(54) PRINT CONTROL APPARATUS AND NON-TRANSITORY COMPUTER-READABLE STORAGE MEDIUM STORING PRINT CONTROL PROGRAM

(71) Applicant: SEIKO EPSON CORPORATION, Tokyo (JP)

(72) Inventors: Jin HASEGAWA, Shiojiri (JP); Shusuke KIBUNE, Matsumoto (JP)

(21) Appl. No.: 19/675,561

(22) Filed: May 13, 2026

(30) Foreign Application Priority Data
May 15, 2025 (JP) 2025-081655

(51) Int. Cl. G06K 15/02; G06K 15/00

(52) U.S. Cl. CPC G06K 15/1809; G06K 15/002; G06K 15/1823; G06K 15/1825; G06K 15/1878; G06K 15/407

(57) ABSTRACT

A print control apparatus for controlling printing by a print apparatus based on pixel data including color information expressed by RGB and additional information for one pixel includes an acquisition section that acquires the pixel data and color material information indicating a color material that is printable on a medium by the print apparatus, a display controller that displays the at least one color material or a specific color expressed by a combination of a plurality of the color materials based on the color material information, and an input region for receiving a designation of the additional information for printing with the color material or the specific color, and a processing section that generates print data that is processable by the print apparatus based on the pixel data and the designation received by the input region.

The present application is based on, and claims priority from JP Application Serial Number 2025-081655, filed May 15, 2025, the disclosure of which is hereby incorporated by reference herein in its entirety.

### BACKGROUND

### 1. Technical Field

The present disclosure relates to a print control apparatus and a non-transitory computer-readable storage medium storing a print control program.

### 2. Related Art

As described in JP-A-2013-156774, it is known that a file, such as a file of png or tiff, may have opacity or transparency information (α channel) in addition to color information, such as RGB.

A method of utilizing an α channel may vary depending on a user operation or a printing method. Therefore, it has been desired that the user can set usage of the α channel.

### SUMMARY

According to an aspect of the present disclosure, a print control apparatus for controlling printing by a print apparatus based on pixel data including color information expressed by RGB and additional information for one pixel includes an acquisition section that acquires the pixel data and color material information indicating a color material that is printable on a medium by the print apparatus, a display controller that displays the at least one color material or a specific color expressed by a combination of a plurality of the color materials based on the color material information, and an input region for receiving a designation of the additional information for printing with the color material or the specific color, and a processing section that generates print data that is processable by the print apparatus based on the pixel data and the designation received by the input region.

According to another aspect of the present disclosure, a non-transitory computer-readable storage medium stores a print control program that causes a print control apparatus for controlling printing by a print apparatus based on pixel data including color information expressed by RGB and additional information for one pixel to function as an acquisition section that acquires the pixel data and color material information indicating a color material that is printable on a medium by the print apparatus, a display controller that displays the at least one color material or a specific color expressed by a combination of a plurality of the color materials based on the color material information, and an input region for receiving a designation of the additional information for printing with the color material or the specific color, and a processing section that generates print data that is processable by the print apparatus based on the pixel data and the designation received by the input region.

### BRIEF DESCRIPTION OF THE DRAWINGS

FIG. 1 is a block diagram illustrating a configuration of a print control apparatus and a print apparatus.

FIG. 2 is a diagram illustrating an example of a data structure of print job data.

FIG. 3 is a diagram illustrating an example of preset information.

FIG. 4 is a view illustrating examples of designation UIs for designating the correspondence between additional information and a specific color material type.

FIG. 5 is a flowchart of a preset registration process.

FIG. 6 is a flowchart of an individual setting process.

FIG. 7 is a diagram illustrating examples of designation UIs.

FIG. 8 is a diagram schematically illustrating an example of the data structure of the print job data.

FIG. 9 is a diagram illustrating an example of print job data.

FIG. 10 is a view illustrating an example of the print job data.

### DESCRIPTION OF EMBODIMENTS

Embodiments of the present disclosure will be described in the following order.
1 Overall Configuration
1-1 Configuration of Print Apparatus
1-2 Configuration of Print Control Apparatus
2 Preset Registration Process
3 Other Embodiments

### 1 Overall Configuration

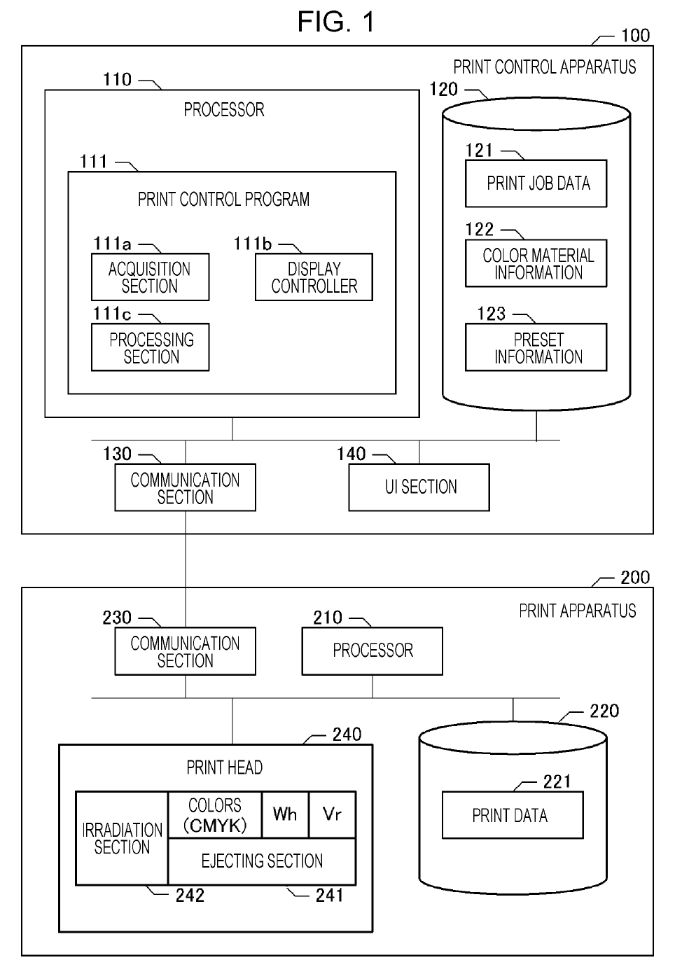

FIG. 1 is a block diagram illustrating a print control apparatus 100 and a print apparatus 200 according to this embodiment. The print control apparatus 100 according to this embodiment generates print data 221 based on print job data 121 and causes the print apparatus 200 to perform printing based on the print data 221. The print control apparatus 100 is, for example, a personal computer, a tablet, or a smartphone. The print apparatus 200 performs printing on a medium based on the print data 221 transmitted from the print control apparatus 100.

### 1-1 Configuration of Print Apparatus

The print apparatus 200 uses inks as color materials. The print apparatus 200 performs printing on a printing medium using predetermined inks. In this embodiment, the predetermined inks are color inks (inks of colors of cyan (C), magenta (M), yellow (Y), and black (K)) and spot inks. The spot inks are used to express colors that cannot be expressed by the color inks, or to provide a base of a color ink layer, gloss of a surface, a three-dimensional effect, or the like. The print apparatus 200 of this embodiment can use a white ink (Wh) and a varnish ink (Vr) as the spot inks. In addition, the color inks and the spot inks that are used by the print apparatus 200 of this embodiment are UV inks which are cured by irradiation with ultraviolet light.

The print apparatus 200 includes a processor 210, a storage medium 220, a communication section 230, and a print head 240. The processor 210 includes a CPU, a RAM, and a ROM, and controls the print apparatus 200 by executing programs stored in the ROM, the storage medium 220, and the like. Note that the processor 210 may be configured by a single chip or a plurality of chips, or may be configured as an SoC together with various functional blocks for operating the print apparatus 200. Furthermore, for example, an ASIC may be adopted instead of the CPU, or a configuration may be adopted in which the CPU and the ASIC cooperate with each other. When each of the apparatuses in this embodiment includes a processor, the processor can be implemented in various forms, similarly to the processor 210.

The communication section 230 includes a circuit used for communication with an external device, such as the print control apparatus 100, according to various wired or wireless communication protocols. The storage medium 220 stores various programs including a print execution program for controlling execution of printing and various types of information. Furthermore, when receiving print data 221 from the print control apparatus 100, the storage medium 220 stores the print data 221 at least until printing indicated by the print data 221 is completed.

The print head 240 ejects UV inks onto a printing medium and irradiates the printing medium with ultraviolet light. The processor 210 performs ejection of the inks and the irradiation of the ultraviolet light with respect to the printing medium while moving the print head 240 via a driving mechanism of the print head 240. The print head 240 includes an ejecting section 241 that is used to eject various inks, and an irradiation section 242 which irradiates the inks ejected by the ejecting section 241 with ultraviolet light. The ejecting section 241 includes nozzles used for ejecting the individual inks of the color inks (CMYK), the white ink (Wh), and the varnish ink (Vr), and applies each of the inks to the printing medium by ejecting the ink onto the printing medium. The irradiation section 242 is a lamp that is disposed in the ejecting section 241 and irradiates ultraviolet light.

When the print data 221 is received by the communication section 230, the processor 210 controls the print head 240 according to print data pieces of individual layers included in the print data 221 and executes printing. The processor 210 produces a printed matter in which a plurality of layers are stacked by performing printing based on the print data pieces of all the layers included in the print data 221.

### 1-2 Configuration of Print Control Apparatus

A user of the print control apparatus 100 inputs the print job data 121 acquired from a creator of the print job data 121 to the print control apparatus 100 that executes a print control program 111. The print control apparatus 100 generates the print data 221 based on the print job data 121 by executing the print control program 111. Furthermore, the print control apparatus 100 transmits the print data 221 to the above-described print apparatus 200 and causes the print apparatus 200 to execute printing based on the print data 221.

The print control apparatus 100 includes a processor 110, a storage medium 120, a communication section 130, and a UI section 140. The processor 110 includes a RAM, a ROM, a CPU, and the like, and controls the print control apparatus 100 by executing various programs stored in the ROM, the storage medium 120, and the like.

The communication section 130 includes a circuit used for communication with an external device, such as the print apparatus 200, in accordance with various wired or wireless communication protocols. The UI section 140 includes an input section that receives a user's operation on a mouse, a keyboard, a touch pad, a touch panel, or the like, and an output section that is used to present information to the user, such as a display (display section) or a speaker.

The storage medium 120 stores various programs including the print control program 111 for causing the print apparatus 200 to execute printing, and various pieces of information, such as the print job data 121, color material information 122, and preset information 123.

The print job data 121 is a file of an image to be printed, and is pixel data including color information expressed by RGB (Red, Green, Blue) and additional information for one pixel in this embodiment. In other words, the print job data 121 of this embodiment is data in a raster format. The print job data 121 is, for example, a png file or a tiff file. Hereinafter, color information of each pixel is also referred to as a color channel, and additional information of each pixel is also referred to as an α channel.

A method of utilizing the α channel may vary depending on a request from the creator of the print job data 121, a printing method, or the like. Therefore, it is desired that the user of the print control apparatus 100 can set a usage of the α channel. The print control apparatus 100 of this embodiment provides the user with a user interface for setting the association between an α channel and a color material.

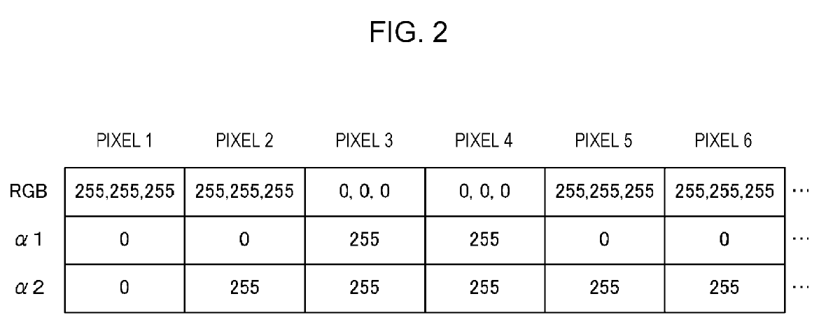

FIG. 2 is a diagram illustrating an example of a data structure of the print job data 121. As illustrated in FIG. 2, the print job data 121 as pixel data includes a color channel including values of three channels of RGB and α channels for individual pixels. In the example of FIG. 2, the number of α channels is two, but the number of α channels may be only one or three or more. In this embodiment, each of the channels is represented by a gradation value of 0 to 255. Furthermore, in the example of FIG. 2, the print job data 121, which is pixel data, includes six pixels from pixel 1 to pixel 6. However, the number of pixels included in the pixel data may be plural, and the number is not particularly limited.

The color material information 122 indicates color materials printable on a medium by the print apparatus 200. In this embodiment, information indicating the color inks (C, M, Y, K), information indicating the white ink (Wh), and information indicating the varnish ink (Vr) are stored as the color material information 122. Note that, in this embodiment, the color material information 122 is input by the user of the print control apparatus 100 and stored in the storage medium 120.

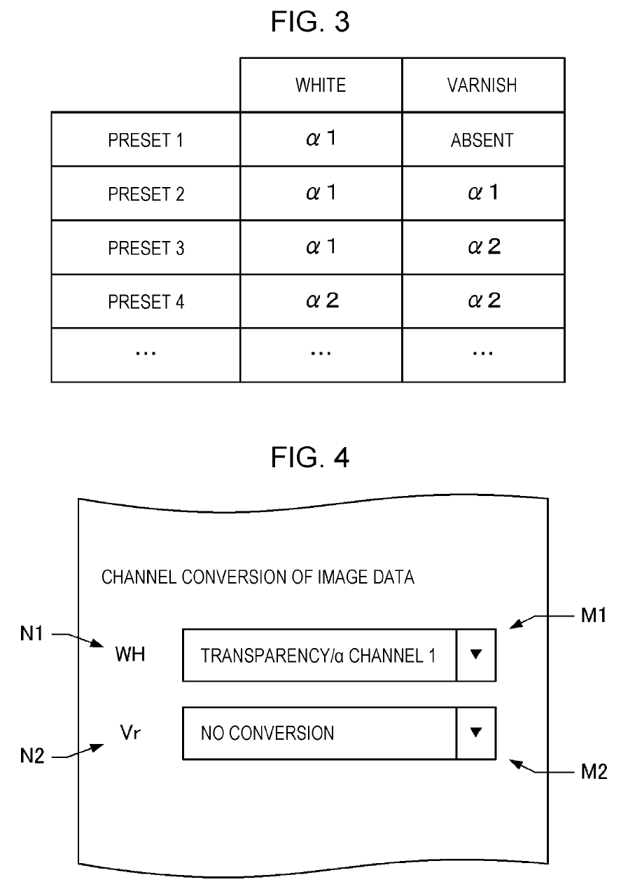

The preset information 123 indicates a pattern of association between ink colors printable by the print apparatus 200 and the α channels. The preset information 123 is generated by the processor 110 executing the print control program 111 to receive a preset registration operation of the user. FIG. 3 is a diagram illustrating an example of the preset information 123. For example, preset 1 is information indicating that a gradation value of each pixel of α channel 1 is used as a gradation value of white, and the varnish is not printed (any α channel is not converted as print data of the varnish). Furthermore, for example, preset 2 is information indicating that a gradation value of each pixel of α channel 1 is used as gradation values of both white and varnish. For example, preset 3 is information indicating that a gradation value of each pixel of α channel 1 is used as a gradation value of white and a gradation value of each pixel of α channel 2 is used as a gradation value of varnish. For example, preset 4 is information indicating that a gradation value of each pixel of α channel 2 is used as gradation values of both white and varnish.

The print control program 111 executed by the processor 110 is so-called RIP (Raster Image Processor) software having a function of generating the print data 221 in a format that can be processed by the print apparatus 200 based on the print job data 121. By executing the print control program 111, the processor 110 functions as an acquisition section 111a, a display controller 111b, and a processing section 111c.

With the function of the acquisition section 111a, the processor 110 acquires the print job data 121 serving as the pixel data and the color material information 122. That is, when the user of the print control apparatus 100 performs an operation of inputting the print job data 121 to the processor 110 that executes the print control program 111, the processor 110 acquires the print job data 121. Furthermore, when the user performs an operation of inputting the color material information 122 of the print apparatus 200, the processor 110 acquires the color material information 122 of the print apparatus 200.

By the function of the display controller 111b, the processor 110 causes a display of the UI section 140 to display at least one of the color materials based on the color material information 122 and an input region for receiving a designation of additional information for printing using the color material. That is, the processor 110 causes the display section to display a user interface for causing the user to set the association between the color materials that can be used for printing by the print apparatus 200 and the α channels.

In this embodiment, the processor 110 causes the user to register an association pattern in advance and stores the association pattern as the preset information 123 before an input of the print job data 121. FIG. 4 is a diagram illustrating examples of designation UIs for designating the association between additional information and a specific color material type, which is a UI for registering the preset information 123 for the print apparatus 200. The designation UI illustrated in FIG. 4 is displayed when the specific color material type is included in the color material information 122 of the print apparatus 200. In this embodiment, specific color material types are white and varnish. As illustrated in FIG. 4, in the designation UIs, names N1 and N2 of color materials that are the specific color material types, and input regions M1 and M2 for designating association with the color materials are displayed. The input region for the color material named N1 is M1, and the input region for the color material named N2 is M2. In this embodiment, the input regions M1 and M2 are in the form of a pull-down menu, and the options of the pull-down menu include "no conversion", "transparency/α channel 1", and "α channel 2". "No conversion" is an option indicating that none of the α channels is used to generate print data of a corresponding color material. "Transparency/α channel 1" is an option indicating that the α channel 1 used as data indicating transparency of a color channel is also used to generate print data of a corresponding color material. Furthermore, "α channel 2" is an option indicating that the α channel 2 is used to generate print data of a corresponding color material. Note that the input regions may be implemented by a UI in a form other than the pull-down menu.

When the user performs an operation of selecting and registering a desired option from the pull-down menu for each of the inks of the specific color material types displayed on the designation UIs, the processor 110 stores content selected by the user as the preset information 123 in association with the specific ink type. Note that the preset information 123 may be registered in a plurality of patterns as illustrated in FIG. 3. An arbitrary name or description may be set for each preset.

With the function of the processing section 111c, the processor 110 generates the print data 221 that can be processed by the print apparatus 200 based on the print job data 121 which is pixel data and the designations received in the input regions. In this embodiment, the user selects any of the registered preset information 123 as a preset to be applied when generating the print data 221 based on the print job data 121. The processor 110 generates the print data 221 by applying the preset information 123 selected by the user.

In this embodiment, the print data 221 is halftone data generated for each print layer. The print layers of this embodiment may include a white ink layer, a color ink layer, and a varnish ink layer. The halftone data defines the presence or absence of ejection of ink of each of the ink colors of the print apparatus 200 and a size of an ink droplet for each pixel. In this embodiment, since the α channel 1 is used as data indicating the transparency of the color channel, the processor 110 performs a color conversion process on the gradation values of the individual ink colors as the color inks based on values of pixels of the color channel of the print job data 121 and values of pixels of the α channel 1 as the transparency, and further performs a halftone process to generate the print data of the color channel. For example, a pixel having a value of 255 in the α channel 1 indicates that a target pixel in the color channel is completely opaque. The print data of the layers other than the color ink layer is generated based on the applied preset information 123. For example, when the applied preset information 123 indicates that the α channel 1 is associated with white, the processor 110 sets the gradation values of the individual pixels of the α channel 1 as the gradation value of white, and performs the halftone process to generate the print data of the white ink layer. For example, a pixel having a value of 255 in the α channel 1 indicates that a pixel having the maximum white density. For example, when the applied preset information 123 indicates that the α channel 2 is associated with varnish, the processor 110 sets the gradation values of the individual pixels of the α channel 2 as the gradation value of varnish, and performs the halftone process to generate the print data of the varnish ink layer. Note that, for example, when the applied preset information 123 indicates that none of the α channels is allocated to the varnish, the processor 110 omits the generation of the print data of the varnish ink layer.

As described above, the processor 110 generates the print data 221 configured by the halftone data of the individual print layers. Note that the printing order of the print layers can be designated by the user. For example, the user can designate the printing order such that the printing is performed on the medium in the order of the white ink layer, the color ink layer, and the varnish ink layer.

When the generation of the print data 221 is completed, the processor 110 transmits the print data 221 to the print apparatus 200. When the print data 221 is received, the processor 210 of the print apparatus 200 executes printing based on the print data of the individual layers according to the printing order indicated by the print data 221.

As described above, according to this embodiment, it is possible to allow the user to specify a usage of the α channels included in the print job data 121. Therefore, for example, even when the same print job data 121 is input, the user can apply a variety of preset information 123 as illustrated in FIG. 3 so as to cause the print control apparatus 100 to generate the print data 221 corresponding to the preset information 123.

Meanwhile, in the white ink and the varnish ink, pixels to which ink droplets are ejected and pixels to which ink droplets are not ejected are common, and gradation values of the pixels to be ejected are also common in some cases. When it is fixed in the RIP software that the α channel 1 is allocated to the white ink and the α channel 2 is allocated to the varnish ink, the creator of the print job data 121 needs to create print job data including the data for the α channel 1 and the data for the α channel 2 having the same structure. However, according to this embodiment, the creator of the print job data 121 may create the print job data 121 including data of one α channel. When the creator of the print job data 121 requests to use the α channel 1 included in the print job data 121 for both white printing and varnish printing at a time of submission, the user of the print control apparatus 100 can cause the print control apparatus 100 to generate the print data 221 indicated by content of the request by applying a preset (see, for example, preset 2 in FIG. 3) indicating that the α channel 1 is converted into print data of the white ink layer and similarly the α channel 1 is converted into print data of the varnish ink layer.

In addition, as a file format, there is a format in which the number of α channels is determined to be only one. When such a format is adopted for the print job data 121, the user can include only one α channel in the print job data 121 of the format. According to this embodiment, since the print control apparatus 100 can allocate this one channel to, for example, both white and varnish, the creator can make a request to print, for example, both the white ink layer and the varnish ink layer even when the print job data 121 has a format that can include only one α channel.

Furthermore, according to this embodiment, the creator of the print job data does not need to modify the print job data in accordance with the specification of the RIP software. For example, in a case where there are first RIP software whose specification determines that the α channel 1 is allocated to the white ink and the α channel 2 is allocated to the varnish ink and second RIP software whose specification determines that the α channel 1 is allocated to the varnish ink and the α channel 2 is allocated to the white ink, the creator needs to create print job data according to the respective specifications. However, in the case of the print control program 111 of this embodiment, since the user can determine a usage of the α channels included in the print job data, the creator does not need to perform correction, such as changing the order of the data of the α channels included in the print job data. For example, in a case where print job data created for the first RIP software is used in the print control program 111 of this embodiment, the user can divert the print job data as it is without correcting the order or structure of the α channels of the print job data.

Furthermore, as described above, the usage of the α channel is roughly divided into two, that is, a usage as a value indicating transparency (or opacity) for a color channel and a usage as a gradation value of an ink color other than color inks. Therefore, for example, there are a use case in which a white ink layer used as a base of a color ink layer is desired to have a gradation value based on the transparency of a color channel, and a use case in which a white ink layer of an arbitrary form is desired to be formed without being based on the transparency. More specifically, for example, when printing is performed on a transparent medium, there are a use case in which it is desired to use the gradation of the transparency of the color ink layer also in the white ink layer, and a use case in which it is desired to set white to an arbitrary gradation value (for example, a maximum of 255) for pixels to which the color inks are applied, regardless of the transparency. In the former case, since the α channel indicating the transparency can be assigned to white, the creator does not need to create another α channel to be assigned to white. In the latter case, the user can create data indicating the gradation value of white as an α channel different from the α channel indicating the transparency, and the user of the print control apparatus 100 can assign the different α channel to white by the print control program.

As described above, according to this embodiment, the user can set the usage of the α channels of the print job data 121. Therefore, it is possible to improve convenience in printing based on the print job data 121 including the α channels.

### 2 Preset Registration Process

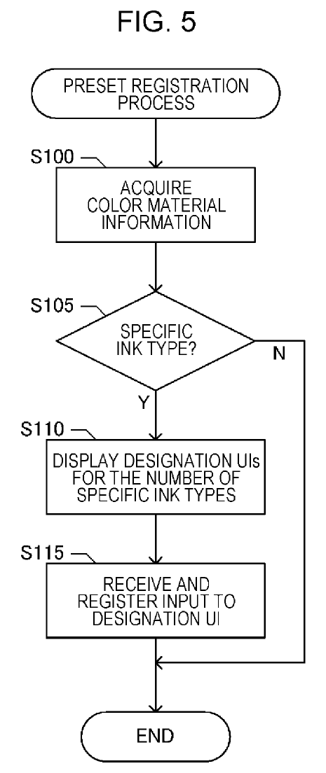

FIG. 5 is a flowchart of the preset registration process. The preset registration process of FIG. 5 is executed when the user instructs the print control apparatus 100 that is executing the print control program 111 to perform preset registration regarding a method of utilizing the α channels for the print apparatus 200. The preset registration is performed by the user, for example, when the print apparatus 200 is newly introduced. When the preset registration process is started, the processor 110 acquires the color material information by the function of the acquisition section 111a (step S100). When the user of the print control apparatus 100 inputs an ink type printable by the print apparatus 200 by operating the UI section 140, the processor 110 acquires information indicating the input ink type and stores the information as the color material information 122.

Subsequently, the processor 110 determines whether a specific ink is present by the function of the display controller 111b (step S105). In this embodiment, the processor 110 regards inks other than the color inks (C, M, Y, K) as the specific ink type (specific color material type). The processor 110 determines whether information indicating the specific ink type is included in the color material information 122.

In step S105, when it is not determined that there is a specific ink type, the processor 110 terminates the preset registration process. That is, when the specific ink type is not included in the ink types that can be printed by the print apparatus 200, the processor 110 terminates the preset registration process without displaying the designation UIs which will be described later (that is, non-display). In this way, by not displaying the designation UI when the specific color material type is not included in the color material information, it is possible to prevent the user from performing unnecessary settings. Note that, as another embodiment, the input regions may be disabled while the designation UIs are displayed. In the case of this configuration as well, it is possible to cause the user to omit unnecessary settings.

In step S105, when it is determined that there is a specific ink type, the processor 110 displays designation UIs for the number of specific ink types using the function of the display controller 111b (step S110). As illustrated in FIG. 4, the designation UIs include the names N1 and N2 of the specific color material types and the input regions M1 and M2 for receiving designations of additional information for printing using the color materials. For example, when the specific ink types included in the color material information 122 are two types of the white ink and the varnish ink, the processor 110 displays the designation UIs for the white ink and the varnish ink individually. In this way, in a case where the specific color material types are included in the color material information, it is possible to cause the user to perform necessary settings by displaying the designation UIs in a state where an input is acceptable.

Subsequently, the processor 110 receives inputs to the designation UIs and registers the input as the preset information 123 by the function of the display controller 111b (step S115). That is, when the user selects desired options for the individual input regions M1 and M2 and performs a registration operation, the processor 110 stores a pattern of associations between the specific ink types and the options as the preset information 123.

Note that the user can register a plurality of patterns of the preset information 123 by instructing the execution of the preset registration process a plurality of times.

After performing the preset registration, the user of the print control apparatus 100 can input the print job data 121 received from the creator to the processor 110 that executes the print control program 111. The user of the print control apparatus 100 inquires of the creator about an intended use of a channel of the additional information. The user of the print control apparatus 100 applies the preset information 123 suitable for an intended use and instructs the print control program 111 to generate the print data 221. To be specific, when acquiring the print job data 121 by the function of the acquisition section 111a, the processor 110 displays a UI for selecting one of pieces of the registered preset information 123 to be applied, and acquires the preset information 123 selected by the user.

The processor 110 uses the function of the processing section 111c to apply the acquired preset information and generates the print data 221 based on the print job data 121. The processor 110 transmits the generated print data 221 to the print apparatus 200. Upon receiving the print data 221, the print apparatus 200 drives the print head 240 based on the print data 221 to perform printing on a medium.

### 3 Other Embodiments

The above-described embodiment is merely an example of implementing the present disclosure, and various other embodiments may also be adopted. For example, the print control apparatus 100 and the print apparatus 200 may be integrated as hardware, and the above-described processing may be performed by the print control apparatus included in the print apparatus 200. The color material may include various types of material for coloring a medium, in addition to ink. Furthermore, the type of ink is not limited to UV ink. The printing method is not limited to the ink jet method.

The specific color material type may be configured to include at least a pretreatment agent, a post-treatment agent, a transparent color material, a white color material, or a metallic color material. The pretreatment agent is, for example, a reaction liquid for improving color development of ink. The post-treatment agent is, for example, a liquid for protecting a medium on which the color ink is printed, and is specifically, for example, varnish, an overcoat liquid, or clear coating. The transparent color material is used to provide a glossy appearance or a three-dimensional appearance, and is, for example, a varnish ink. The white color material is used, for example, as a base of the color ink layer. The metallic color material contains a reflective material. With this configuration, the print control apparatus can associate various specific color material types with the additional information.

The pixel data may be image data including color information expressed by RGB and additional information for one pixel. That is, the pixel data may be image data of a format supporting a so-called α channel. The pixel data may be, for example, a psd file, a bmp file, or the like other than a png file and a tiff file.

The display controller may be configured to be able to display a specific color expressed by a combination of color materials based on the color material information and an input region for receiving a designation of the additional information for printing in the specific color. That is, in the above-described embodiment, an α channel to be assigned to each specific ink type is designated, but a specific color indicated by an arbitrary spot color name and the α channel to be assigned to the specific color may be designated. Specifically, for example, the creator of the print job data 121 creates data indicating an image (for example, a figure indicating a company logo) to be printed in a specific color on any α channel X. In a designation UI (for example, see FIG. 4), an input region for inputting a designation of an arbitrary spot color name and an α channel to be associated with the spot color name is displayed. Note that the arbitrary spot color name may be input by the user of the print control apparatus 100. The user designates an α channel X in the input region as the α channel to be associated with the arbitrary spot color name. The description will be continued assuming that the specific color indicated by the arbitrary spot color name can be alternatively expressed by a combination of gradation values of the ink colors (CMYK) of the color inks. When generating print data based on data of the α channel X, the print control apparatus 100 generates the print data based on a combination of the gradation values of the color inks for expressing the specific color. With such a configuration, the processor 110 can designate a specific color designated by an arbitrary spot color name as a color for printing an image of the α channel X.

Furthermore, when it is designated that any one of the α channels is allocated to an arbitrary spot color name, a UI for designating the order of a layer of the arbitrary spot color name and the color ink layer (the order of printing on the medium) may be displayed. With such a configuration, the user can designate the printing order of the color ink layer and the layer indicated by the arbitrary spot color name.

The acquisition section may be configured to acquire the color material information based on a result of communication between the communication section and the print apparatus. For example, a configuration may be adopted in which model information of the print apparatus is stored in the storage section of the print apparatus, the acquisition section acquires the model information from the print apparatus by the communication section, and the color material type printable by the print apparatus of the model information is specified with reference to a database of the model information. Alternatively, the color material type printable by the print apparatus may be stored in the storage section of the print apparatus, and the acquisition section may be configured to acquire the color material type from the print apparatus by the communication section. With this configuration, the color material information corresponding to the print apparatus used for printing pixel data can be acquired from the print apparatus.

In addition, color material containers (also referred to as cartridges) which are set in the print apparatus and accommodate the color materials may include a storage section which stores identification information for identifying types of the accommodated color materials, and the print apparatus may be configured to read the identification information of the set color material containers. In this case, the acquisition section may be configured to acquire the color material information indicated by the identification information from the print apparatus. When the identification information itself of each of the set color material containers is transmitted from the print apparatus, the acquisition section may be configured to refer to a database of the identification information of the color material container and identify a type of the color material contained in the set color material container. In a case where the print apparatus is configured to specify color material types accommodated in the color material containers from the identification information of the set color material containers and to transmit information indicating the specified color material types, the acquisition section can acquire the color material information by the information transmitted from the print apparatus. In any case, with such a configuration, the print control apparatus can acquire color material information indicating a color material that is actually set and usable. For example, even in a print apparatus which can use both the varnish ink and the white ink, there may be a case where one of the inks is not used and therefore a cartridge of the ink is not set in the print apparatus. According to this configuration, in such a case, it is possible to receive a designation of the additional information for an ink that is actually mounted, and it is possible to prevent erroneous settings.

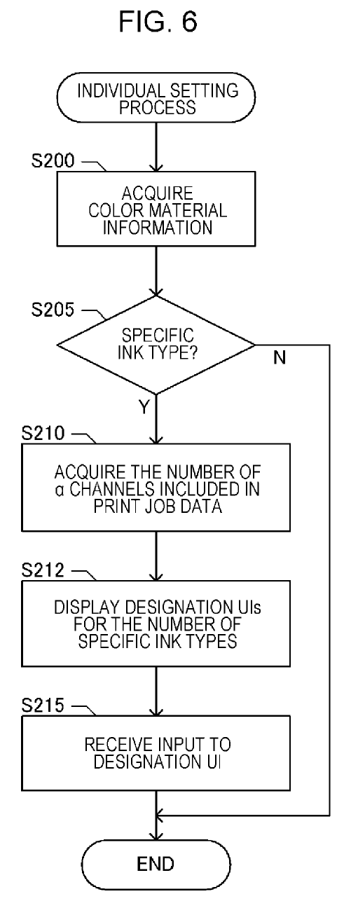

In the above embodiment, the example in which the number of α channels is up to two has been described, but the number of α channels may be an arbitrary number of three or more. Furthermore, in the above-described embodiment, the preset information 123 is registered in advance, and a preset to be applied to generation of the print data 221 of the print job data 121 is selected from the registered preset information 123. However, the correspondence between a specific ink type and an α channel may be designated for each print job data 121 when the print job data 121 is input. In this case, the display controller may be configured to display different options in the input regions in accordance with the number of channels of the additional information included in the pixel data acquired by the acquisition section. FIG. 6 is a flowchart of the individual setting process. The individual setting process in FIG. 6 is started when the user inputs the print job data 121. In the individual setting process, step S200 and step S205 are the same as step S100 and step S105 illustrated in FIG. 5, and a description thereof will be omitted. When it is determined in step S205 that there is a specific ink type, the processor 110 acquires the number of α channels included in the print job data 121 by the function of the display controller 111b (step S210). That is, the processor 110 analyzes a header of a file of the print job data 121 and acquires information indicating the number of channels.

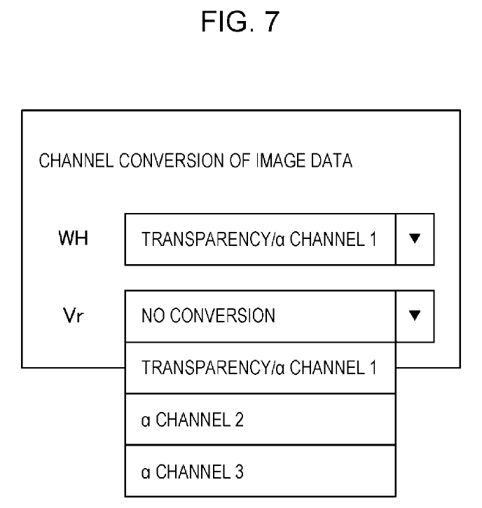

Subsequently, the processor 110 displays designation UIs corresponding to the number of specific ink types by the function of the display controller 111b (step S212). At this time, the processor 110 displays options reflecting the number of α channels included in the print job data 121. FIG. 7 illustrates an example of options when the number of α channels included in the print job data 121 is three. Specifically, it is indicated that "no conversion", "transparency/α channel 1", "α channel 2", and "α channel 3" are presented as options.

Subsequently, the processor 110 receives inputs to the designation UIs by the function of the display controller 111b (step S215). That is, the processor 110 acquires the correspondence relationships between the specific ink types and the α channels associated with the specific ink types, and applies the correspondence relationships to the process of generating the print data 221 for the print job data 121.

With such a configuration, the processor 110 can display options corresponding to the number of channels of the additional information of the print job data 121, and can receive a selection by the user from among the options.

The display controller may be configured to analyze pixel data, determine a color material to be associated with additional information in accordance with a result of the analysis, and display the determined correspondence relationship. That is, the correspondence relationship between the additional information and the color material may be automatically determined and displayed based on values of pixels included in the pixel data or information included in a header of a file. That is, the print control apparatus may propose a correspondence relationship between additional information and a color material, which is considered to be appropriate, to the user. More specifically, the display controller performs control such that an initial value when the pull-down menu illustrated in FIG. 4 is displayed has a correspondence relationship between additional information and a color material which is considered to be appropriate. With this configuration, a burden on the user of the print control apparatus can be reduced. Of course, the user of the print control apparatus may be allowed to change the automatically determined and displayed correspondence relationship.

As an aspect of automatically determining the correspondence relationship, the display controller may be configured to determine a color material to be associated with a channel of additional information based on the positional relationship between an ink application region (color material application region) in the channel (color channel) of the color information and an ink application region (color material application region) in a channel (α channel) of the additional information, and display the determined correspondence relationship. For example, a case where print job data including an α channel 1 and an α channel 2 in addition to a color channel is input will be described. The processor 110 analyzes data of the color channel to obtain a contour of the ink application region of the color channel. Furthermore, the processor 110 analyzes each of the data of the α channel 1 and the data of the α channel 2, and acquires a contour of the ink application region in the α channel 1 and a contour of the ink application region in the α channel 2.

It is known that an application region of the white ink is at the same position and has the same shape as an application region of the color inks, or the application region of the white ink is inside the application region of the color inks (that is, smaller than the application region of the color inks) in many cases. In addition, it is known that an application region of the varnish ink protrudes from the application region of the color inks (that is, larger than the application region of the color inks) in many cases. The processor 110 determines the correspondence between the specific ink types and data of the α channels based on the relationship between a shape and a position of the contour.

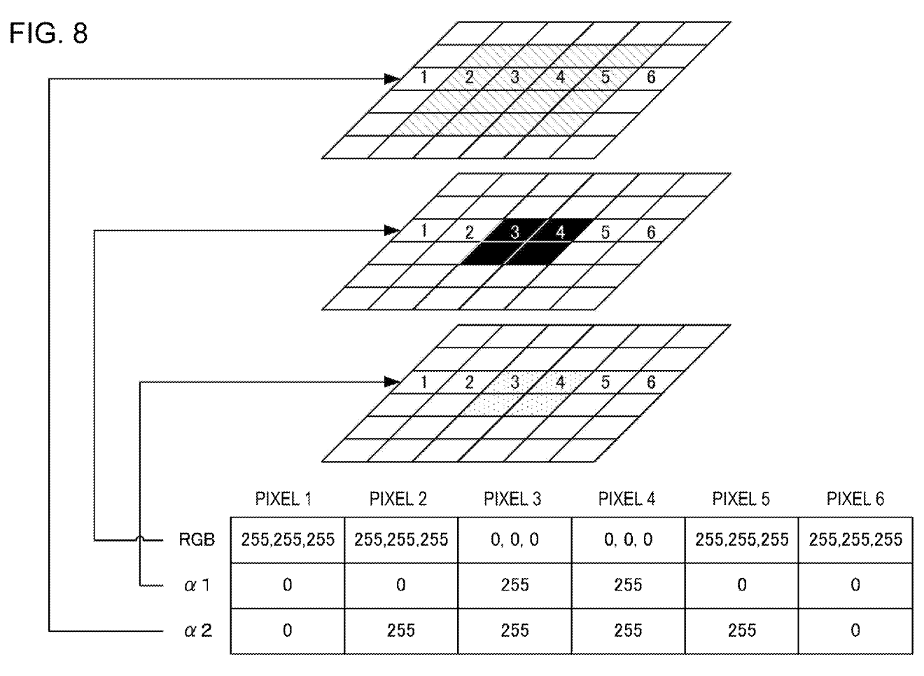

In the example illustrated in FIG. 8, the ink application region of the α channel 1 is at the same position and has the same shape as the application region of the color inks, and the ink application region of the α channel 2 is larger than the application region of the color inks by one pixel each in the vertical and horizontal directions. Note that, in this example, in the α channel 1 and the α channel 2, the processor 110 determines that pixels having gradation values which are not 0 are pixels constituting an ink application region. Furthermore, the processor 110 determines that pixels having gradation values other than (255, 255, 255) indicating white in the color channel constitute an ink application region. When such an analysis result is obtained, the processor 110 determines that the α channel 1 is allocated to white and the α channel 2 is allocated to varnish. With such a configuration, it is possible to automatically determine the correspondence relationships between the α channels and the specific ink types based on shapes of ink application regions of the channels of print job data.

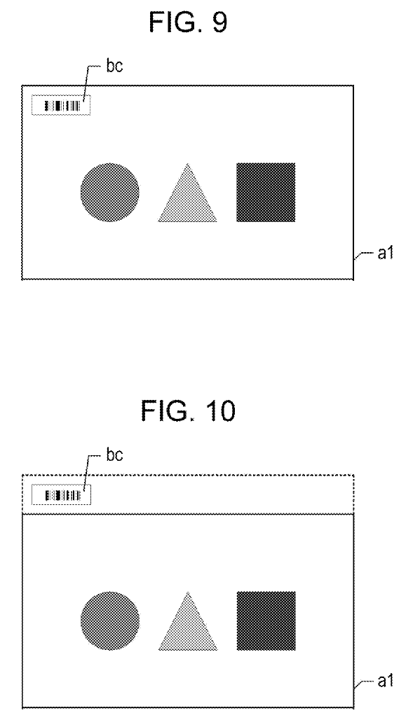

As another example of automatically determining the correspondence relationship, the display controller may be configured to read designation information represented by a plurality of pixels included in pixel data, determine a color material to be associated with a channel of additional information based on the designation information, and display the determined correspondence relationship. The designation information may be in a form of characters, a barcode, or a two-dimensional code. For example, as illustrated in FIG. 9, the creator creates print job data in which a barcode bc of a non-background color indicating a method of utilizing an α channel is embedded in a region of a background color (for example, white) in a print range a1 of an image of a color channel. The barcode as the designation information includes, for example, information indicating that the α channel 1 is allocated to white and the α channel 2 is allocated to varnish. When such print job data is input, the processor 110 analyzes the barcode bc and acquires the method of utilizing the α channel. Then, the processor 110 determines the correspondence relationships between the α channels and the color materials according to content indicated by the barcode bc. Note that, when generating the print data of the color channel, the processor 110 generates the print data by converting the barcode bc into the background color. That is, the barcode bc is not formed on the medium. The barcode bc may be arranged within the print range a1 as illustrated in FIG. 9, or may be arranged outside the print range a1 as illustrated in FIG. 10.

Even when an application for creating print job data does not have a specification capable of adding designation information which is arbitrary information of a creator to a header of a file of the print job data, the creator can embed the designation information represented by a plurality of pixels included in the pixel data as described above. Therefore, even for a creator who creates print job data by using an application that does not have the above-described specification, designation information for designating a method of utilizing the α channel can be included in the print job data itself. The processor 110 can automatically determine the correspondence relationship between an α channel and a specific ink type by analyzing the print job data including such designation information.

Note that, as still another example of automatically determining the correspondence relationship, the display controller may be configured to acquire designation information included in a header of pixel data, determine a color material to be associated with additional information based on the designation information, and display the determined correspondence relationship. That is, when designation information for designating a method of utilizing additional information is included in the header of the file of the print job data, the processor 110 acquires the designation information included in the header. With this configuration, the processor 110 can automatically determine the correspondence relationship between an α channel and a specific ink type.

Furthermore, the present disclosure can also be applied as a print control program or a print control method executed by a computer. Furthermore, the system, the program, and the method as described above may be implemented as a single apparatus or may be implemented by using components included in a plurality of apparatuses, and include various forms. The configuration described above may also be modified such that the configuration is implemented by a combination of software and hardware. In addition, the present disclosure can also be realized as a recording medium for a program for controlling the system. It is needless to say that the storage medium for storing the program may be a magnetic storage medium or a semiconductor memory, and any storage medium that will be developed in the future can be considered in exactly the same way.

What is claimed is:

1. A print control apparatus for controlling printing by a print apparatus based on pixel data including color information expressed by RGB and additional information for one pixel, the print control apparatus comprising:
an acquisition section that acquires the pixel data and color material information indicating a color material that is printable on a medium by the print apparatus;
a display controller that displays the at least one color material or a specific color expressed by a combination of a plurality of the color materials based on the color material information, and an input region for receiving a designation of the additional information for printing with the color material or the specific color; and
a processing section that generates print data that is processable by the print apparatus based on the pixel data and the designation received by the input region.

2. The print control apparatus according to claim 1, further comprising:
a communication section that communicates with the print apparatus, wherein
the acquisition section acquires the color material information based on a result of communication between the communication section and the print apparatus.

3. The print control apparatus according to claim 2, wherein
a color material container that is set in the print apparatus and accommodates the color material stores identification information for identifying a type of the accommodated color material,
the print apparatus reads the identification information of the set color material container, and
the acquisition section acquires the color material information indicated by the identification information from the print apparatus.

4. The print control apparatus according to claim 1, wherein
the display controller changes an option to be displayed in the input region in accordance with the number of channels of the additional information included in the pixel data.

5. The print control apparatus according to claim 1, wherein
the display controller
displays the input region when a specific color material type is included in the color material information, and
does not display or invalidate the input region when the specific color material type is not included in the color material information.

6. The print control apparatus according to claim 5, wherein
the specific color material type includes at least one of a pretreatment agent, a post-treatment agent, a transparent color material, a white color material, or a metallic color material.

7. The print control apparatus according to claim 1, wherein
the display controller analyzes the pixel data, determines the color material to be associated with the additional information in accordance with a result of the analysis, and displays a determined correspondence relationship.

8. The print control apparatus according to claim 7, wherein
the display controller determines the color material to be associated with a channel of the additional information based on a positional relationship between a color material application region in a channel of the color information and a color material application region in the channel of the additional information, and displays a determined correspondence relationship.

9. The print control apparatus according to claim 7, wherein
the display controller reads designation information represented by a plurality of pixels included in the pixel data, determines the color material to be associated with a channel of the additional information based on the designation information, and displays a determined correspondence relationship.

10. The print control apparatus according to claim 7, wherein
the display controller acquires designation information included in a header of the pixel data, determines the color material to be associated with the additional information based on the designation information, and displays a determined correspondence relationship.

11. A non-transitory computer-readable storage medium storing a print control program, the print control program causing a print control apparatus for controlling printing by a print apparatus based on pixel data including color information expressed by RGB and additional information for one pixel to function as:
an acquisition section that acquires the pixel data and color material information indicating a color material that is printable on a medium by the print apparatus;
a display controller that displays the at least one color material or a specific color expressed by a combination of a plurality of the color materials based on the color material information, and an input region for receiving a designation of the additional information for printing with the color material or the specific color; and
a processing section that generates print data that is processable by the print apparatus based on the pixel data and the designation received by the input region.
